(19) United States
(12) Patent Application Publication
(10) Pub. No.: US 2025/0343338 A1
(43) Pub. Date: Nov. 6, 2025

(54) Method for producing a battery assembly for a battery module, and a battery assembly

(71) Applicant: Webasto SE, Stockdorf (DE)

(72) Inventors: Martin Sacher, Stockdorf (DE); Arne Müller, Stockdorf (DE); Rosemarie Barth, Stockdorf (DE)

(21) Appl. No.: 19/198,366

(22) Filed: May 5, 2025

(30) Foreign Application Priority Data
May 6, 2024 (DE) 102024112716.3

(51) Int. Cl. H01M 50/588; C09J 5/08; H01M 10/613; H01M 10/643; H01M 10/653; H01M 10/6554; H01M 50/213; H01M 50/293

(52) U.S. Cl. CPC H01M 50/588; C09J 5/08; H01M 10/613; H01M 10/643; H01M 10/653; H01M 10/6554; H01M 50/213; H01M 50/293

(57) ABSTRACT

A method for producing a battery assembly for a battery module, comprising the following steps: providing a battery cell block comprising a plurality of battery cells, where a battery cell block top side has one or more electrical contacts (of the plurality of battery cells; applying a foaming adhesive onto or into a mold; positioning the battery cell block on or in the mold and inserting the battery cell block top side into the foaming adhesive so that the battery cell block top side is at least partially wetted by the foaming adhesive in order to form contact protection for the battery cell block top side by means of the foaming adhesive; waiting until the foaming adhesive adheres to the battery cell block top side; and removing the battery cell block from or out of the mold.

### CROSS-REFERENCE TO RELATED APPLICATION

This application claims priority to German Application No. DE 102024112716.3 filed on May 6, 2024, which is incorporated herein by reference in its entirety for all purposes.

### TECHNICAL FIELD

The present disclosure relates to a method for producing a battery assembly for a battery module, and to a corresponding battery assembly for a battery module

### BACKGROUND

It is known to provide specific components or areas of a battery, e.g. the drive or traction battery of an electric vehicle, with electrically insulating contact protection so that the battery meets specific requirements, e.g. various regional regulatory requirements.

This applies for example to live components such as conductor rails, busbars, battery terminals or battery module connections. In the case of high-voltage systems (>60 V), for example, compliance with protection against accidental contact (e.g. in accordance with IPXXB) is relevant for occupational safety.

For example, when fitting a module cover to a pre-assembled and connected battery block, there is a risk of electric shock for the worker if the worker is not protected against the live components of the connected battery cell block.

One known solution is that battery terminals and electrical connectors for connecting the terminals are each individually electrically insulated during the connection process, i.e., the electrical connection of individual battery cells in parallel or in series, in order to provide contact protection for the battery block, which is thus pre-assembled and connected. For example, the terminals and/or the connectors can have pre-assembled individual sheaths that form an overall sheath for the live components during the connection process. Such sheaths can be provided, for example, by using plastics-molded components. A disadvantage of this known solution is that the assembly of plastics-molded components is very complex, especially if a continuous sheathing is to be achieved.

### SUMMARY

Based on the known prior art, it is an object of the present invention to provide an improved method for producing a battery assembly and an improved battery assembly.

The problem is solved by the method having the features of claim 1. Advantageous further embodiments are shown in the dependent claims, the description and the figures.

Accordingly, a method for producing a battery assembly for a battery module is proposed, comprising the following steps:
providing a battery cell block comprising a plurality of battery cells, wherein a battery cell block top side has one or more, e.g. at least two, electrical contacts of the plurality of battery cells;
applying a foaming adhesive onto or into a mold;
positioning the battery cell block on or in the mold and inserting the battery cell block top side into the foaming adhesive so that the battery cell block top side, e.g. the one or more electrical contacts, is at least partially wetted by the foaming adhesive to form a contact protection for the battery cell block top side, e.g. the one or more electrical contacts, by means of the foaming adhesive;
waiting until the foaming adhesive adheres to the battery cell block top side;
removing the battery cell block from or out of the mold.

For example, the battery module can be a battery module for a drive or traction battery, for example for a drive battery of an electrically powered vehicle. Additionally or alternatively, the battery module can be a battery module for a building battery to supply a building.

In the present case, the term “electrical contacts” includes e.g. the positive terminal and the negative terminal of a battery cell of the plurality of battery cells. The respective battery cell can, for example, be a cylindrical cell, i.e., a so-called round cell, or a prismatic cell. The terminals of an individual battery cell can, for example, be arranged on a common side or on opposite sides of the battery cell. For the sake of simplicity, it is assumed here that the battery cell is a round cell with upper terminals, i.e., that both terminals are arranged on an end-face top side of the round cell. However, the present disclosure can also be applied equally to battery cells with both terminals arranged on an end-face bottom side of the cell and to battery cells with terminals arranged on opposite sides.

The battery cell block can be provided, for example, by attaching the battery cells to each other or by holding the battery cells in a block-like arrangement by a holding device. The term “battery cell block” therefore refers to a geometric arrangement of the battery cells, e.g. in a uniform pattern.

For example, the battery cell block can be provided in the form of a dense packing of cylindrical cells, also known as round cells, of substantially the same size and orientation, so that the top sides of the battery cells lie substantially in one plane and provide the battery cell block top side. The individual battery cells can then be attached to each other, for example by means of interposed adhesive beads, to form the battery cell block.

The foaming adhesive can be intended to form an adhesive foam material by foaming. In other words, the foaming adhesive is thus designed to provide the adhesive foam material by means of foaming.

For example, the foaming adhesive can be a mixture of substances comprising a two-component adhesive and optional additives. The foaming adhesive or the mixture of substances can substantially be present in three different states: In a first state, the mixture of substances has not yet hardened, has not yet developed any significant adhesive strength and is substantially not yet foamed. In a second state, the foaming of the material mixture or the foaming adhesive can take place or be in progress, wherein the material mixture can expand significantly in volume and can already provide an initial adhesive force or adhesion to the joining partners. The second state can be seen as a transitional state between the first and third states. In the subsequent third state, the foamed or expanded material mixture can then be cured and/or it can develop its full adhesive strength.

The preparation of the foaming adhesive relates e.g. to the preparation in the first state and can be carried out, for example, by mixing two components of the material mixture with each other in a linear mixer, e.g. in a counter-jet high-pressure process. Typically, the foaming adhesive is applied, i.e., the foaming adhesive is applied to the mold immediately or quickly after the two components have been mixed.

The application of the foaming adhesive to the mold can, on the one hand, be a direct application of the foaming adhesive to a surface of the mold. In other words, the adhesive can be brought into direct contact with the surface of the mold during application. On the other hand, the application of the foaming adhesive to the mold can be an indirect application of the foaming adhesive to the mold or into the mold. In other words, a release agent or a release layer may be provided between the surface of the mold and the adhesive to be applied, as will be explained in more detail later.

The mold can have a mold base that corresponds geometrically to the battery cell block top side to be formed or is designed independently of it. For example, electrical contacts, e.g., the positive terminals, of the battery cells on the battery cell block top side can lie substantially in one plane and the mold base can be designed accordingly to be substantially flat or level. Alternatively, the mold base can be profiled in such a way that its profile corresponds to a relief of the battery cell block top side to be formed. The relief of the battery cell block top side can be formed, for example, by the height differences between electrical contacts, e.g. the terminals, and by the contours of electrical connectors, which can be arranged on the battery cell block top side to connect the electrical contacts.

In the context of introducing the battery cell block top side into the foaming adhesive, the battery cell block can be turned 180° in advance from a normal position in which the battery cell block top side points upwards, for example, i.e., against gravity in the present context of a manufacturing process, so that the battery cell block top side points towards the mold or the mold base, i.e., downwards. The battery cell block can then be inserted or immersed with the battery cell block top side into the adhesive applied directly or indirectly to the mold.

By introducing the battery cell block with its battery cell block top side into the foaming adhesive so that the battery cell block top side, e.g. the one or more electrical contacts, is at least partially wetted by the foaming adhesive, the foaming adhesive can wet the battery cell block top side, e.g. the electrical contact or contacts located on the battery cell block top side, even before curing or final bonding, i.e., even before the third state is reached. In this way, the foaming adhesive can be used to provide electrical contact protection for the battery block top side, e.g. the at least one or the electrical contacts located on the battery cell block top side. The fact that the adhesive is a foaming adhesive, i.e., expands e.g. in the second state and finally forms a foam material in the third state, means that the components, e.g. electrical parts, located on the battery cell block top side can be wetted particularly effectively. For example, a partial enclosure or enveloping of these components or electrical parts can be achieved. In this way, contact protection for the battery cell block top side can be provided particularly easily and effectively.

By subsequently waiting until the foaming adhesive adheres to the battery cell block top side, it is possible to ensure that the adhesive develops at least sufficient adhesive strength so that the adhesion of the adhesive to the battery cell block top side e.g. can overcome opposing forces. Opposing forces can result, for example, from the force of gravity acting on the adhesive or they can relate to a slight adhesion of the adhesive to the mold surface. In this way, the risk of unwanted adhesive remaining on or in the tool mold can be minimized.

The term “waiting” in this context means that the battery cell block remains in its position on or in the mold for a certain period of time until the foaming plastic adheres to the battery cell block top side.

According to the disclosure, a contact protection for the battery cell block top side in the form of the foaming adhesive can therefore already be provided on the battery cell block positioned on or in the mold. This means that the battery cell block top side, and e.g. the at least one electrical contact, is already protected against electric shock when the battery cell block is removed from or out of the mold. In this way, the safety for a worker can be increased or alternatively necessary safety measures can be dispensed with, so that production is more efficient.

After waiting, the battery cell block is removed from the mold. For example, removal can take place before the foaming adhesive has hardened or reached the third state.

For example, the foaming adhesive can already provide the contact protection in the second state described above, i.e., when the adhesive has not yet completed its foaming or expansion, but already adheres to the battery cell block top side thanks to the waiting described above. This means that the waiting time can be kept comparatively short or the removal can take place comparatively quickly, so that cycle time on the mold can be reduced or saved, while at the same time the removed battery cell block is already protected against electric shock. For example, the waiting time can be in the range of a few seconds.

Furthermore, removal can take place when the adhesive is in the second state, i.e., still adhering or still sticky. If no release layer was provided in the mold in a previous step, an outer layer, for example in the form of a lid or a film, can be applied to the still adhering adhesive after removal. In this way, the outer layer can be bonded to the battery cell block top side by means of the foaming adhesive as it hardens and develops its full adhesive strength.

Irrespective of an outer layer as described above, the foaming adhesive as such can on the one hand provide contact protection and on the other hand also provide a mechanical connection between the battery cells of the battery cell block and any electrical connectors present. Consequently, a monolithic structure can be provided so that, for example, a separate holder for holding the battery cells together can be dispensed with.

Furthermore, the following step can be carried out before the foaming adhesive is applied to the mold: Providing an anti-adhesive agent on or in the mold in order to prevent the foaming adhesive from adhering to the mold. In this way, the adhesive can substantially adhere exclusively to the intended joining partner, i.e., the battery cell block top side.

According to a development, the provision of the anti-adhesive agent on or in the mold can be carried out using an anti-adhesive coating with which the mold is coated. The anti-adhesive coating may comprise materials such as silicone or Teflon and/or may be a typical anti-adhesive coating for adhesives. For example, the anti-adhesive coating can be designed in such a way that it is anti-adhesive to the foaming adhesive, for example to a polyurethane-based adhesive. In other words, the anti-adhesive coating can be designed to avoid or prevent adhesion of the foaming adhesive to the mold.

Additionally or alternatively, the provision of the anti-adhesive agent on or in the mold can be carried out using the following step: Applying a release agent onto or into the mold. For example, the release agent may be designed to avoid or prevent adhesion of the foaming adhesive to the mold. The release agent can be a release agent known in the prior art, for example in the form of a spray, a paste or a liquid. For example, the release agent can be volatile. In the present context, a volatile release agent is understood to be a release agent that substantially does not remain or should not remain in the product to be manufactured. For example, the release agent can be removed from the battery cell block top side after it has fulfilled its function.

According to a development, the provision of the anti-adhesive agent on or in the mold can be carried out by means of the following step: providing a release layer on the mold, wherein the release layer is intended to be attached to the battery cell block by means of the foaming adhesive, so that the release layer is provided in the form of an outer layer for the battery cell block top side. In other words, the mold can be equipped or provided with a release layer before the foaming adhesive is applied to the mold. In this case, the adhesive is applied to the mold indirectly as described above. The release layer can thus take on a dual function in that it prevents the adhesive from adhering to the mold and can also provide additional protection or a structural component for the battery cell block, for example, in the form of an outer layer attached to the battery cell block top side by means of the adhesive. In this way, the production process and the resulting product can have a high degree of functional integration. According to this further development, the outer layer can also be referred to as an integrated-mounted outer layer.

According to an alternative development, the following step can be carried out after removing the battery cell block from or out of the mold: Providing the foaming adhesive with an outer layer. In this case, for example, the adhesive can adhere to the mold by means of the anti-adhesive coating or the release agent, as described above, and the mold does not need to be provided with a release layer, which later remains on the battery cell block as an outer layer. Instead, the battery cell block e.g. can be removed at such a time that the foaming adhesive is still adherent or still tacky, in other words has not yet reached the third state. The outer layer can thus be bonded to the battery cell block top side by means of the foaming adhesive, so that the outer layer can, for example, provide additional protection or a structural component for the battery cell block. According to this alternative further development, the outer layer can also be referred to as a post-installed outer layer.

When the present disclosure refers to “the outer layer”, this refers to both of the above-mentioned alternative embodiments, i.e., both to the integrated outer layer and to the subsequently applied outer layer. If only one of the two variants is meant, this is specifically addressed.

Furthermore, the outer layer can be a lid, a film or a lacquer. For example, the outer layer can be electrically insulating. In this way, additional or improved contact protection can be provided for the battery assembly.

For example, the mold can be provided with the lid or the film as a separating layer before the adhesive is applied, so that the lid or the film is consequently provided as an integrated outer layer.

In other words, the lid or film can be placed on or within the mold or inserted into the mold to provide the lid/film on or in the mold. In other words, the mold is first equipped with the lid/film before the foaming adhesive is applied to the lid/film. In this context, applying the adhesive to the lid naturally means applying the adhesive to the inside of the lid.

By attaching the lid to the battery cell block using the foaming adhesive inside the mold in accordance with the above example, improved contact protection for the battery cell block top side in the form of the lid can already be provided in the mold. Furthermore, the lid can already protect the battery cell block against dirt in the mold. In other words, the battery cell block top side is protected against electric shock and dirt when the battery cell block is removed from the mold.

Thanks to the foaming adhesive, the improved contact protection can be securely and robustly attached to the battery cell block. In addition, the components in contact with the foaming adhesive are thus joined to each other or to the battery assembly, e.g. the battery cells, but also the electrical connectors, so that the structural strength and/or rigidity of the contact protection on the battery cell block increases. In this way, the foaming adhesive also fulfills an assembly function within the battery assembly, independently of the attachment of the lid. In this way, the degree of functional integration of the battery assembly is increased, which means an increase in cost-effectiveness compared to conventional processes.

For example, a vacuum can be provided between the mold and the lid/film and holds the lid/film in the mold in the correct position for the subsequent steps. Furthermore, the subsequent removal of the battery assembly with the glued-on lid/film can be facilitated by removing the vacuum or by providing a corresponding overpressure.

The fact that, according to the above example, the foaming adhesive is not applied directly to the mold surface but to the inside of the lid means that a release agent commonly used in bonding processes to protect the mold surface can be dispensed with. Rather, the battery assembly, i.e., the battery cell block together with the initially bonded lid, can be removed from the mold without leaving any adhesive residue in the mold and without impairing the bonding of the lid to the battery cell block as the open time of the adhesive elapses.

Because the mold is already fitted with the lid in advance, the lid immediately provides protection against contact and contamination as soon as the battery cell block top side is inserted into the foaming adhesive.

In another example, the lacquer may be provided in or on the mold before the adhesive is applied. In this case, the mold can be provided with an anti-adhesive coating and/or a release agent in order to prevent the lacquer from adhering to the mold. Furthermore, a coating can be selected which is non-adhesive to the mold, e.g. to its surface, so that the coating acts as a release agent on the one hand and on the other hand is intended to remain on the battery cell block top side as an integrated outer layer.

In another example, after the removal step, the lid or film can be attached as a post-installed outer layer to the still-tacky foaming adhesive to be bonded to the battery cell block.

In another example, the lacquer can be applied to the foaming adhesive after the removal step as a subsequently applied outer layer. Depending on the choice or design of the adhesive or lacquer, the lacquer can be applied while the adhesive is still tacky or already cured.

Furthermore, the outer layer and the foaming adhesive can together form a composite material. For example, the outer layer and the foaming adhesive can together form a composite substrate, which is formed by means of layers bonded together, e.g. by means of layers bonded together over the entire surface. In this way, a particularly robust and reliable contact protection can be provided.

The method may further comprise at least one of the following steps:
heating the foaming adhesive prior to application to an application temperature such that the application temperature does not exceed a first threshold value, e.g. wherein the first threshold value is in the range 30-40° C.;
controlling a mold surface temperature of the mold so that the mold surface temperature does not exceed a second threshold, e.g. wherein the second threshold is in the range of 30-40° C.

Furthermore, the first and second threshold values can be in the range 25-35° C. if the above two steps are combined, i.e., a heating of the foaming adhesive and a control of the mold surface temperature is provided.

The temperature control for heating the foaming adhesive to the first threshold value leads to a desired higher reaction speed of the material mixture. In this way, the battery cell block can be removed from or out of the mold earlier, saving further production time.

The temperature control of the mold surface temperature can be accompanied by a corresponding temperature control of the integrated outer layer, for example the inside of the lid, to which the adhesive is applied. The temperature difference between the mold surface temperature and the integrated outer layer depends on the material and thickness of the integrated outer layer and can either be insignificant or be taken into account for the temperature control of the mold.

The temperature control of the mold surface temperature towards the second threshold value significantly improves the flowability of the foaming adhesive in the first state, so that the adhesive can be applied in the form of non-overlapping lines and the gaps between the lines can fill themselves thanks to the improved flowability. Thanks to compliance with the second threshold value, the adhesive remains flowable for a sufficiently long time, e.g. without foaming prematurely, so that the gaps can be filled. In this way, the application can be carried out particularly easily and time-efficiently and can be automated particularly well.

It was recognized that exceeding the first or second threshold value can lead to premature foaming, so that not all gaps can be reliably closed.

Thanks to the above-mentioned combination of the two temperature controls, the process times for both adhesive application and foaming can be improved.

Furthermore, the provision of the battery cell block can include the bonding of neighboring battery cells of the plurality of battery cells to each other, e.g. by means of adhesive beads. For example, the bonding can be a structural bonding. In other words, the bonding may be non-detachable, e.g. non-destructively detachable.

The battery cell block can be provided particularly easily by gluing. For example, an adhesive track in the form of a so-called adhesive bead can be applied along the cylindrical surface of a round cell.

This round cell can then be joined to another round cell or to a battery cell block of round cells to be formed.

Furthermore, in a first sub-step, for example, a number of m−1 round cells can each be provided with such an adhesive bead. Then, in a second sub-step, the m−1 round cells can be joined together with another round cell to form a straight row of m round cells. The first and second sub-steps can be repeated to produce a number of n rows. For n−1 rows, two more adhesive beads can be applied along the outer surfaces of the round cells. The n rows can then be joined together to form a battery cell block in the form of a dense cylinder pack. In this way, the battery cell block can be provided particularly efficiently.

Furthermore, thanks to the cells bonded together to form a battery cell block, the battery assembly can have a high structural integrity, particularly in terms of strength and rigidity.

Furthermore, the method can include attaching the battery cell block to a base plate. The base plate can be a thermal plate. Additionally or alternatively, the battery cell block can be attached to the base plate, e.g. the thermal plate, using a thermal filler, for example a thermal adhesive and/or a gap filler. The battery cells can also be bonded to the base plate.

The battery cell block can be attached to a base plate as soon as the battery cell block-in whatever form and in whatever way-is provided. For example, this step can be carried out independently of inserting the battery cell block into the foaming adhesive.

For example, the battery cell block can be provided by holding the battery cells by means of a holding structure. The holding structure can be a manufacturing tool or remain on the battery cell block as part of the battery assembly. The battery cell block can be given the necessary structural strength to carry out the subsequent steps by attaching the base plate. Furthermore, the base plate can only be attached after the battery cell block has been removed from the mold.

The thermal plate can be in the form of a cooling plate or a generally thermally controllable base plate, by means of which the battery cells can be cooled or heated thanks to appropriate battery thermal management. If the battery cell block is attached to the base plate in the form of a thermal plate using a thermal filler, a particularly good thermal connection of the battery cells can be achieved.

Furthermore, the method may include attaching an electrical connector to the battery cell block top side to electrically connect the at least two contacts together.

The step of attaching the electrical connector to the battery cell block top side can take place independently of the step of applying the foaming adhesive to the mold, for example in a synchronized production line. In other words, the electrical connector does not necessarily have to be attached before the foaming adhesive is applied to the mold.

The electrical connector can, for example, be attached by soldering, welding or screwing and can electrically connect battery cells in series or in parallel. For example, the battery assembly to be produced can provide a number x of battery cells connected in series, which provide a so-called string, wherein a number y of such strings can be connected in parallel in the battery assembly, so that the battery assembly as a whole has the product of x times y battery cells. Such a battery assembly can form the basis for a single battery module, wherein several battery modules can be connected to form the overall battery, for example a vehicle battery or a storage battery for buildings. Alternatively, such a battery assembly can already provide the overall battery.

During the process, the electrical connector is also mechanically protected by the cured foaming adhesive, which in other words is an adhesive foam material as described above. For example, vibrations of the electrical connectors in relation to the battery cells can be damped or completely prevented by the foam material, so that a higher fatigue strength can be achieved.

According to a development, the step of providing the release layer on the mold can comprise the following sub-steps:
equipping the mold with a thermoformable lid blank, e.g. wherein the lid blank comprises a PET material, a PP material or a PEF material,
thermoforming the lid blank to obtain the lid,
cooling the lid, e.g. so that the lid temperature drops to the second threshold or below.

A PET material is formed or is substantially formed from polyethylene terephthalate. A PP material is formed or is substantially formed from polypropylene. A PEF material is formed or is substantially formed from polyethylene dicarboxyfuranoate.

For example, the lid blank can be in the form of a flat plate with a thickness of 1 to 2 mm or in the form of a film with a thickness of less than 1 mm. The temperature control of the thermoforming can be selected in such a way that the lid can be cooled quickly to the second threshold or below, for example to 40° C. or below, so that the foaming adhesive can be applied to the inside of the lid in a timely manner while the lid remains on or in the mold.

In this way, the steps of providing the release layer in the form of the lid, applying the foaming adhesive and inserting the battery cell block top side into the foaming adhesive can be carried out in an integrated manner using the same mold, thus saving production time. Furthermore, this can reduce the handling effort for the lids, as only flat plates or films enter the mold as semi-finished products and not prefabricated lids, which take up a comparatively large volume.

Furthermore, the method can provide that the adhesive is applied to the inside of the lid in such a way that the adhesive at least partially foams around an electrical connector connecting the at least two electrical contacts in the course of foaming. For example, the applied adhesive can have an average layer thickness of at least 0.5 mm before foaming, i.e., in the first state. Additionally or alternatively, the average height of the adhesive in the foamed-out state, i.e., in the third state, can be at least 3 mm.

The average layer thickness of the applied adhesive is understood to be a nominal or design layer thickness, i.e., a layer thickness that should substantially be achieved when applying the potting compound. The average height of the adhesive in the foamed state is understood to be a nominal or design height, i.e., a height that the adhesive should at least reach in order to provide temporary contact protection for the electrical components as described above.

For example, the foaming adhesive in an intermediate area between neighboring battery cells or in an intermediate area between a battery cell located on the edge and a lid side wall can have a greater height than the nominal or design height, e.g. due to capillary effects that pull the adhesive upwards against gravity in the first or second state.

Furthermore, the foaming adhesive can be a flame-retardant adhesive, e.g. a polyurethane adhesive, or “PU adhesive” for short. This means that the foam material provided by the foaming adhesive can protect the battery cell block top side, at least in portions, in the event of thermal runaway of neighboring battery modules or battery cells.

Furthermore, the foaming adhesive can have an open time of less than 60 seconds. Alternatively, the open time can have any value in the range of 25 to 120 seconds. In the present case, the open time is understood to be the common definition from bonding processes, namely the period of time in which the parts to be bonded must be joined together. Accordingly, the open time in the present case refers to the maximum period of time from the start of the application of the foaming adhesive to the insertion of the battery cell block into the foaming adhesive. The open time can be set by the temperature control described above so that the open time is sufficiently long for the adhesive to be applied to the lid completely and in good time.

Furthermore, the proposed adhesive may comprise polyol, isocyanate and optionally an activator or accelerator. Using polyol and isocyanate, the adhesive can be provided in the form of a foaming PU adhesive. The accelerator can be used to adjust the open time so that the adhesive can be applied to the lid completely and in good time. Known products can be used as activators or accelerators.

The polyol:isocyanate mixing ratio can be any value in the range 100:75 to 100:90. If an accelerator is used, the mixing ratio of accelerator: polyol can be in the range 1:200 to 2:100.

It was recognized that in the case of open times of less than 60 seconds, a high-pressure mixing head should be used to mix the polyol and isocyanate and apply the resulting adhesive. With such a mixing head, the polyol and isocyanate circulate continuously before mixing.

The high-pressure mixing process can be operated according to the counter-jet principle. In other words, the two components of the foaming adhesive can be blasted against each other in the mixing head and mixed instantaneously, so that short open times with resulting short curing times can be achieved without the need for curing ovens.

In the context of the present disclosure, it was found that setting the open time to a value in the range of 20-50 seconds, for example of around 30 seconds, by using an activator or accelerator and/or by means of the temperature control described leads to a good compromise between process reliability and cycle time minimization for surface areas of the battery cell block top side in the range of around 0.5 to 1.25 m².

The above-stated problem is further solved by a battery assembly having the features of claim 12. Advantageous further embodiments result from the dependent claims as well as the present description and the figures.

Accordingly, a battery assembly is proposed for a battery module comprising a battery cell block having a plurality of battery cells, e.g. cylindrical cells, wherein a battery cell block top side has at least two electrical contacts of the plurality of battery cells. The battery assembly further comprises a foaming adhesive covering the battery cell block top side and at least partially enclosing the two electrical contacts to provide contact protection for the battery cell block top side.

In order to avoid repetition, reference is made to the above description of the proposed method, wherein identical elements and components of the proposed battery assembly and the method described above relate to the same technical teaching and achieve the same technical effects and advantages in each case. Furthermore, identical terms are defined in the same way.

Furthermore, an outer layer can be arranged on the foaming adhesive, which e.g. is electrically insulating. The outer layer can be provided in the form of a lid, a film or a lacquer. For example, the outer layer can be provided as an integrated outer layer or as a subsequently applied outer layer as described above.

Furthermore, the outer layer and the foaming adhesive can together form a composite material, e.g. a composite substrate which is formed from layers bonded together over their entire surface.

Furthermore, the battery assembly can have an electrical connector, wherein the at least two electrical contacts are connected by means of the electrical connector and the foaming adhesive at least partially encloses the electrical connector.

The electrical connector is also mechanically protected by the cured foaming adhesive, which in other words is an adhesive foam material as described above. For example, vibrations of the electrical connector in relation to the battery cells can be damped or completely prevented by the foam material, so that a higher fatigue strength can be achieved.

Furthermore, the plurality of battery cells can be bonded together to provide the battery cell block. The bonding can be provided by means of adhesive beads.

Additionally or alternatively, the foaming adhesive can be arranged between adjacent battery cells of the plurality of battery cells. In this way, adhesive beads can be partially or completely dispensed with, which saves effort.

Furthermore, the battery assembly can have a base plate, e.g. in the form of a thermal plate. The base plate can be attached to the underside of the battery cell block opposite the battery cell block top side by means of a thermal fluid.

Furthermore, an intermediate layer of the foaming adhesive can be arranged between the battery cell block top side and the outer layer. The intermediate layer can have a minimum thickness in the range of 0.5 to 5 mm.

Furthermore, it may be provided that the outer layer covers the at least two electrical contacts and the electrical connector. It can also be provided that the entire battery cell block top side is covered by the outer layer.

In this way, contact protection can be provided in a sandwich design or in the form of a composite material, with both the intermediate layer and the outer layer electrically insulating at least the two contacts and optionally the electrical connector on the battery cell block top side.

Furthermore, the outer layer in the form of the lid or the film can be substantially shell-shaped. For example, the lid can be substantially U-shaped in longitudinal section and in cross-section. In the present case, a U-shape is understood to mean a shape that has a base part and two leg parts of substantially equal length, wherein the two leg parts extend substantially transversely, parallel and in the same direction from the base part.

Because the lid/film can be substantially shell-shaped or U-shaped, the lid/film can cover the battery cell block top side and enclose the transverse sides of the battery cell block top side. Furthermore, the lid/film can also be attached to the transverse sides of the battery cell block top side by means of the adhesive.

Furthermore, the lid can be embossed in its main extension plane. For example, the base part of the U-shaped lid can be embossed or profiled. In this way, the inherent rigidity of the lid can be increased. For example, the foaming adhesive can easily enter the recesses of the embossing or profile during application or in the course of foaming.

### BRIEF DESCRIPTION OF THE DRAWINGS

Preferred further embodiments are explained in more detail in the following description of the figures. They show:

FIG. 1 an embodiment of a method for producing a battery assembly for a battery module;

FIGS. 2a, b a top view and a side view of a battery assembly during the production process;

FIGS. 3a-d a side view of the battery assembly from FIGS. 2a, b during the production process according to one embodiment;

FIG. 3e a side view of a battery assembly according to the disclosure or of the battery assembly from FIGS. 2a, b and FIGS. 3a-d after completion of the production process;

FIGS. 4a-d a side view of the battery assembly of FIGS. 2a, b during the production process according to a further embodiment; and

FIGS. 4e, f a side view of a battery assembly according to the disclosure or of the battery assembly of FIGS. 2a, b and FIGS. 4a-d after completion of the production process.

### DETAILED DESCRIPTION

In the following, preferred exemplary embodiments are described with reference to the figures. Here, identical, similar or similarly acting elements in the different figures are provided with identical reference signs, and a repeated description of these elements is partially dispensed with in order to avoid redundancies.

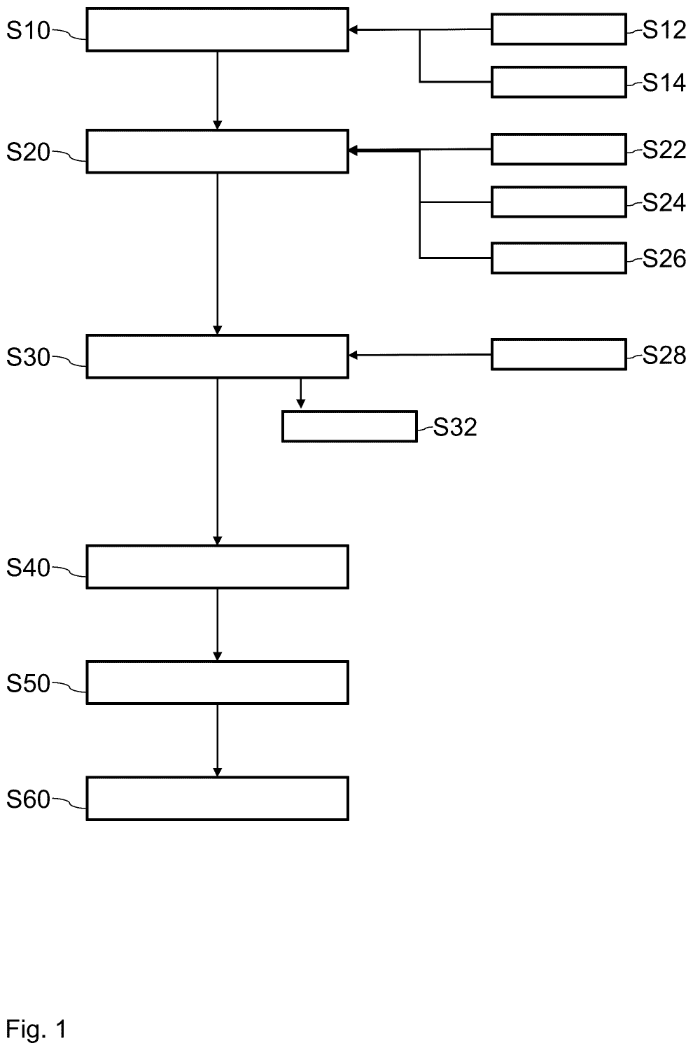

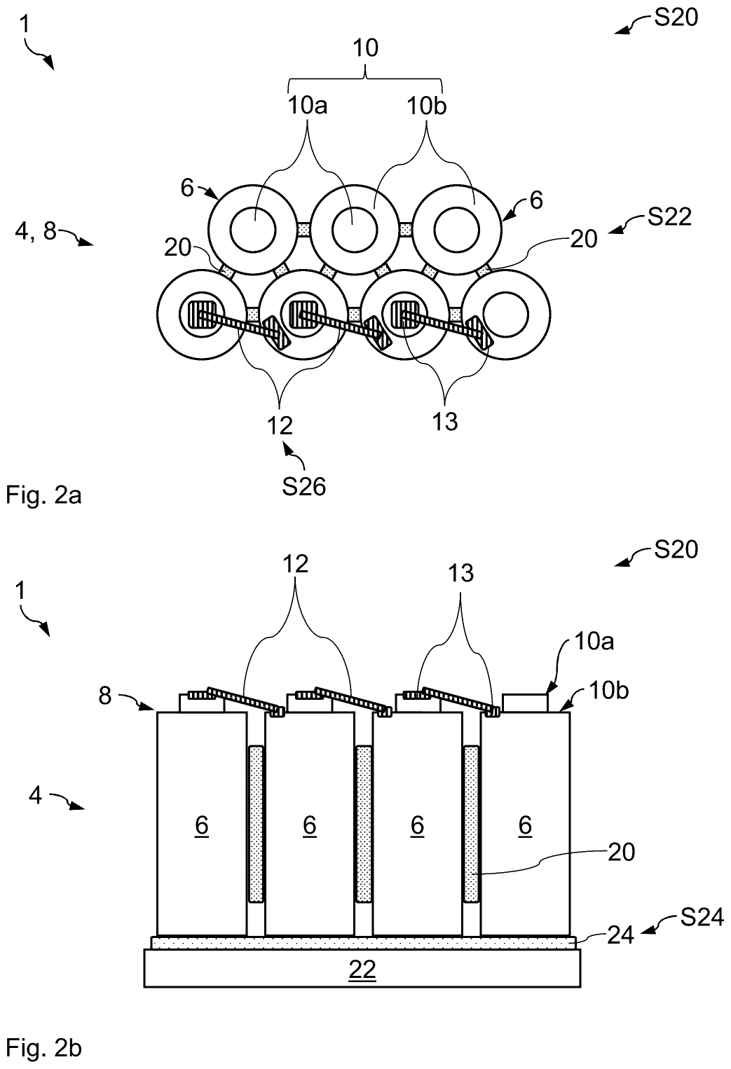

FIG. 1 schematically shows a method for producing a battery assembly 1 for a battery module 2. The reference signs of the components of the battery assembly 1 to be produced according to the method and of the battery assembly 1 according to the disclosure can be taken from FIGS. 2a to 4f.

As can be seen in FIG. 1, a battery cell block 4 of a plurality of battery cells 6 in the form of round cells 6 is provided in a step S10. In the present example, the battery cell block 4 is provided by gluing adjacent round cells 6 together by means of adhesive beads 20 in a step S22 (see FIG. 2a).

In the present case, the directions at the top and bottom correspond to the direction of gravity in a normal orientation (see FIGS. 2b, 3e, 4e, f) of the battery assembly 1. Accordingly, the top side of a battery cell or a battery cell block top side 8 points against gravity in the normal orientation of the battery assembly 1.

Each round cell 6 has two electrical contacts 10, namely a positive terminal 10a and a negative terminal 10b, which in this example are each arranged on the top of the battery cell 6. The negative terminal 10b is arranged around the positive terminal 10a and the positive terminal 10a protrudes from the top of the cell opposite the negative terminal 10b (see FIGS. 2a, b). Alternatively, the terminals could also be arranged on different sides, e.g. on opposite sides of the battery cell.

During the bonding process S22, the battery cells are aligned with each other so that the tops of the positive terminals are arranged in one plane. Thus, the battery cells 6 connected to the battery cell block 4 provide the battery cell block top side 8 with their top sides, which consequently has the electrical contacts 10 or terminals 10a, b.

The difference in height between the positive terminal 10a and the negative terminal 10b is exaggerated in FIGS. 2b to 4f for reasons of representation and is not shown to scale. In fact, the difference in height can be just a few millimeters. In other words, the positive terminal 10a can only protrude a few millimeters from the cell surface relative to the negative terminal.

In a further step S24, the battery cell block 4 is connected to a base plate 22 in the form of a thermal plate 22 using a gap filler 24 (see FIG. 2b).

In a further step S26, electrical connectors 12 are attached to the battery cell block top side 8 in order to electrically connect the contacts 10 of the battery cells 6 (see FIG. 2a). Contacting elements 13 attached or to be attached to the terminals can be provided for contacting the contacts 10, i.e., the terminals 10a, b. The contacting elements 13 can be attached by soldering, for example. The electrical connection of the cells 6 increases the current and/or the voltage of the battery cell block 6, so that the potential risk of electric shock increases accordingly.

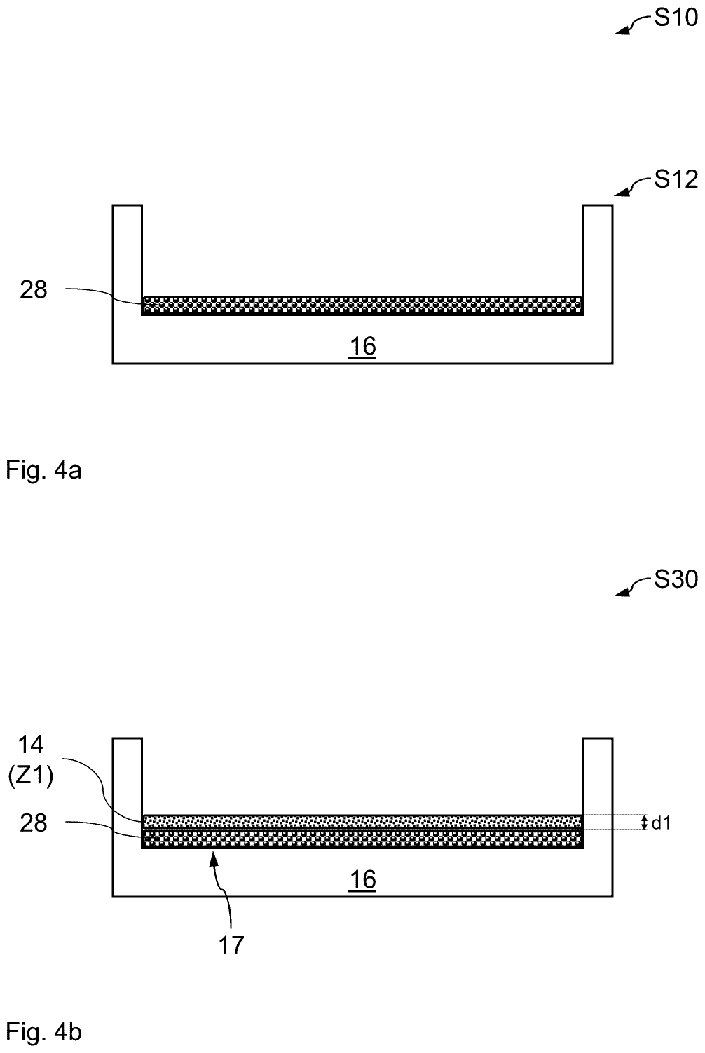

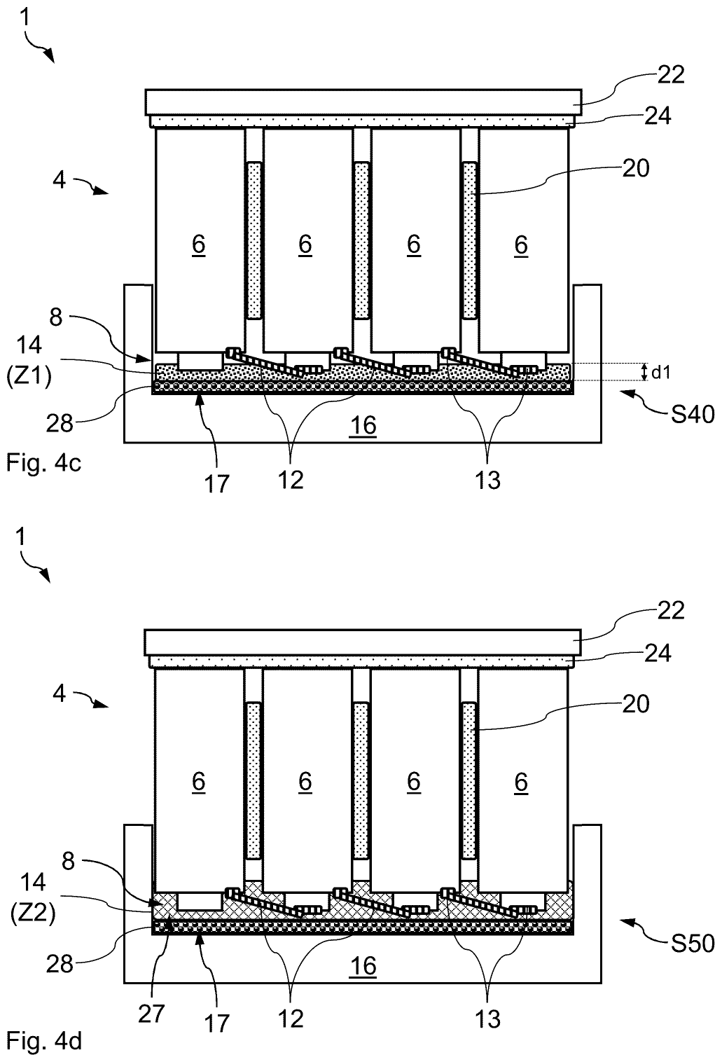

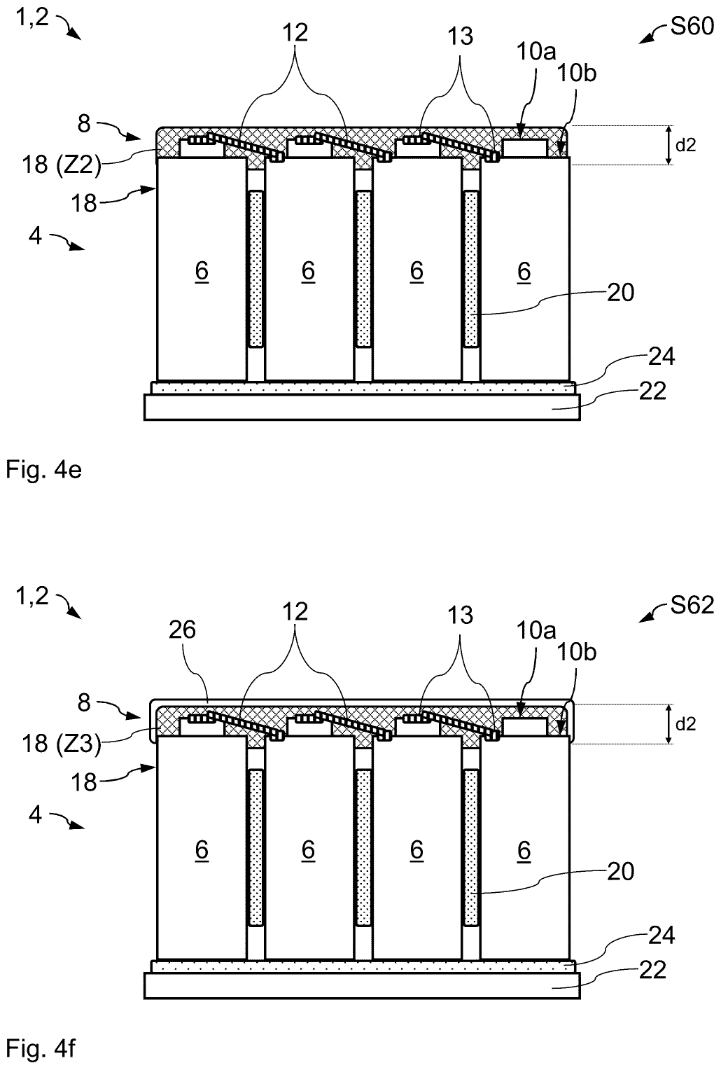

An anti-adhesive agent is provided S10 on the mold 16 independently of step S20 in order to prevent the foaming adhesive 14 from adhering to the mold 16. The provision S10 of the anti-adhesive agent can be carried out, for example, by using a mold 16 coated with an anti-adhesive coating. Additionally or alternatively, the provision S10 of the anti-adhesive agent can be carried out, for example, with the aid of a step S12 in which a release agent (28) is applied to the mold 16 (see FIG. 4a).

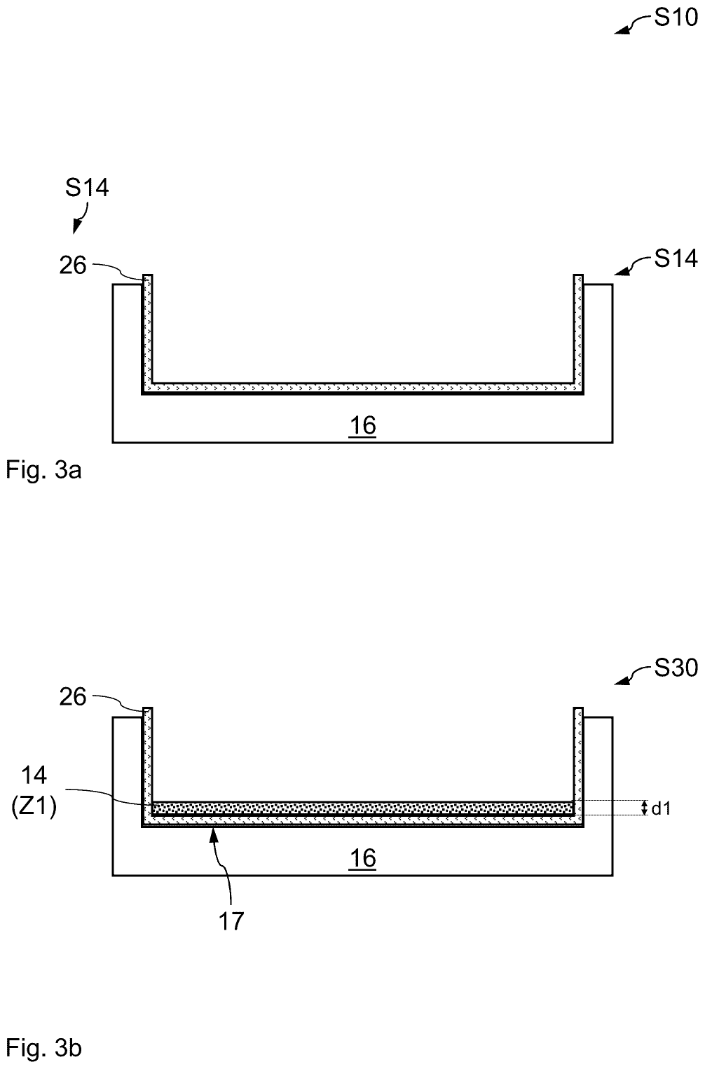

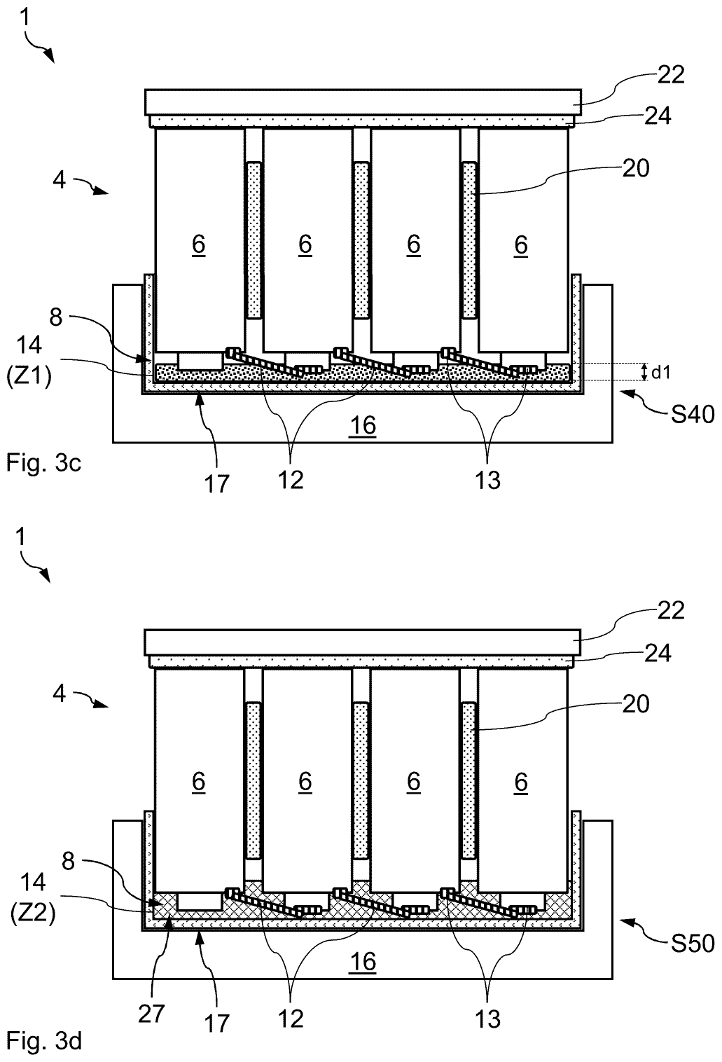

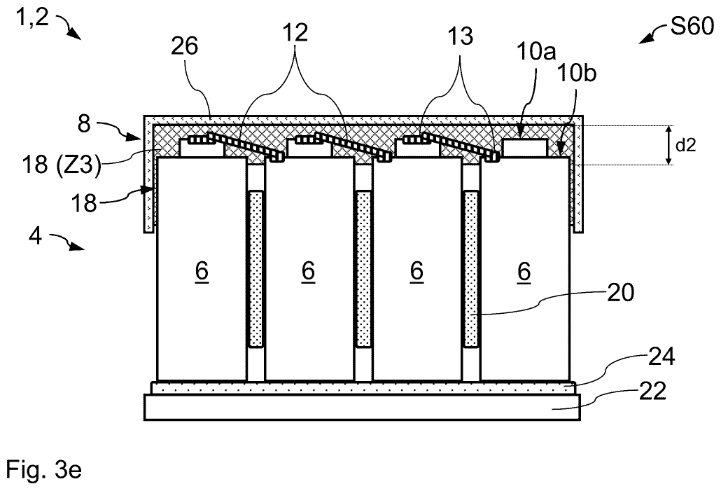

Additionally or alternatively, the provision S10 of the anti-adhesive agent can be carried out, for example, with the aid of a step S14 in which a release layer (26) is provided on or in the mold 16. The release layer may, for example, be provided in the form of a lid 26, which is inserted into the mold 16. The lid 26 may already be prefabricated, so that the lid 26 only needs to be provided on, at or in the mold 16 (see FIG. 3a). In other words, the mold 16 is fitted with the lid 26. As described above, the lid 26 can be in the form of a shell with a U-shaped transverse and longitudinal section, which is inserted into the mold 16.

In a further step, a foaming adhesive 14 is provided and, if necessary, heated in a step 28, i.e., preheated, before the foaming adhesive 14 is applied directly or indirectly to the mold 16 in a step S30. The foaming adhesive 14 is a mixture of substances in the form of a foaming polyurethane adhesive, which can be provided in the present case by mixing the two basic components polyol and isocyanate in a linear mixer.

The adhesive 14 is then applied S30 to the mold 16, for example directly to a mold 16 coated with an anti-adhesive coating, or indirectly to a mold 16 provided with a release layer, for example in the form of the lid 26 (see FIG. 3b) or to a mold 16 provided with a release agent 28 (see FIG. 4b).

Typically, an adhesive 14 with a relatively short open time, e.g. less than 60 seconds, is desired in order to ensure time-efficient production. Accordingly, the mixing and the application S30 of the adhesive can go hand in hand, so that the adhesive 14 freshly mixed in the linear mixer is applied continuously and directly to the mold by means of a nozzle. The applied adhesive 14 can have an average layer thickness d1 of at least 0.5 mm before foaming, i.e., in the first state Z1 (see FIGS. 3b, 4b).

The application S30 can be carried out continuously in serpentine form, so that towards the end of the application S30 a plurality of adjacent lines of adhesive 14 substantially cover the mold 16 or the mold base 17 or the release layer 26. The composition of the adhesive 14 and the process control can obviously be carried out in such a way that the adhesive 14 has sufficient flowability and open time to close any gaps between said lines before the adhesive 14 loses its flowability. Accordingly, during application S30, the adhesive 14 is in the first state described above, which is designated Z1 in FIGS. 3b, c and 4b, c).

Before application S30, the adhesive 14 can be heated to an application temperature in step S28, wherein a first threshold value is not exceeded. If step S28 represents a solitary temperature control for the adhesive 14, i.e., is not carried out in combination with step S32 described below, for example, the first threshold value can be any value in the range 30-40° C.

After the application S30, a further temperature control may be provided in a step S32, namely in the form of controlling a mold surface temperature so that the mold surface temperature does not exceed a second threshold value. If step S32 represents a solitary temperature control for the adhesive 14, i.e., is not carried out in combination with step S28 described above, for example, the second threshold value can be any value in the range 30-40° C.

If both said temperature controls are provided in combination, i.e., both step S28 and step 32 are carried out, then the first and/or second threshold value can have any value in the range 25-35° C., for example around 30° C. in each case. Furthermore, both the first and second threshold values can have any value in the range 30-50° C. in the case of solitary temperature control, that is, when either step S28 or step 32 is carried out. Furthermore, the first and second threshold values can each be reduced by 10K compared to solitary temperature control if the temperature control is not solitary but combined, i.e., if both step S28 and step 32 are carried out.

For the proposed temperature controls, a substance mixture of the adhesive 14 with a polyol:isocyanate mixing ratio in the range 100:75 to 100:90 is assumed.

For example, if the adhesive 14 then provides or forms a substantially gap-free surface on the mold 16 after application S30, the battery cell block 4 is inserted into the adhesive 14, which is substantially in the first state Z1, in a further step S40.

In the present example (see FIGS. 3c, 4c), the battery cell block 4 is inserted S40 upside down and in such a way that the battery cell block top side 8 is at least partially wetted by the adhesive 14. For example, the insertion S40 can be carried out in such a way that a minimum distance of 0.5 to 5 mm is maintained between the battery cell block top side 8 and the mold surface 17 or the release layer 26. In other words, the battery cell block 4 can be inserted into the adhesive 14 (step S40, FIG. 3c) in such a way that the battery cell block 4 is held above the inside of the lid 26 at the said minimum distance. In this way, an intermediate layer of the foaming adhesive 14 can be provided between the battery cell block top side 8 and the lid 26, wherein the intermediate layer has a minimum thickness substantially equal to the minimum spacing. For example, the adhesive 14 in the intermediate layer can thus be provided in the form of a foaming material.

The adhesive 14 can be applied S40 in such a way that the adhesive 14 at least partially foams around the electrical connector 12 during the foaming process (see FIGS. 3c, d, 4c, d). For example, the average height d2 of the adhesive 14 in the foamed-out state, i.e., in the third state Z3, can be at least 3 mm (see FIGS. 3e, 4e, f)

Because the adhesive 14 develops its adhesive force in the second state Z2 (see FIGS. 3d, 4d), e.g. after the battery cell block top side 8 has been inserted into the adhesive 14, the separating layer 26 in the form of the lid 26 can be attached to the battery cell block by means of the foaming adhesive 14, so that—e.g. after the later removal S60—the separating layer 26 is provided in the form of an outer layer 26 for the battery cell block top side 8, as described in step S40 of insertion.

Thus, for example, the battery assembly 1 can already be removed from the mold 16 before the adhesive 14 reaches the third state Z3 (see FIG. 3e), in which it is cured. In this way, curing can take place outside the mold, so that the cycle time on the mold 16 can be reduced.

Accordingly, after a step S50, i.e., waiting until the foaming adhesive 14 adheres to the battery cell block top side 8, a step S60, removal of the battery cell block 4 from the mold 16, can take place, e.g. after the separating layer 26 in the form of the lid 26 adheres to the battery cell block 4 via reaching the second state Z2 of the adhesive 14. Thus, the lid 26 already provides effective contact protection, so that step S60 removal can be carried out without special isolation devices, for example by a worker without any problems.

FIG. 3e schematically shows a side view of a battery assembly 1 according to the disclosure. Similarly, FIG. 3e shows the battery assembly 1 of FIGS. 2a, b and FIGS. 3a-d after completion of the production process. As can be seen in FIG. 3e, the adhesive 14 is drawn into the space 16 between the lid 26, e.g. a lid side wall, and the round cells 6 in the course of foaming in the second state Z2 before removal S60 due to the capillary effect. In this way, the side walls of the lid 26 can be very easily attached to the battery cell block 4

Furthermore, it can be seen from FIG. 3e that the foaming adhesive 14 covers the battery cell block top side 8 and at least partially encloses the at least two electrical contacts 10. In this way, the foaming adhesive provides contact protection for the battery cell block top side 8. In steps S10 or S14 (FIG. 3a), S30 (FIG. 3b), S40 (FIG. 3c), S50 (FIG. 3d), the lid 26 functions as an anti-adhesive agent on the mold 16 in the form of a release layer 26. After step S60 of removal (FIG. 3e) or in the battery assembly according to the disclosure, the lid 26 finally functions as an outer layer 26. As an alternative to a lid 26, the reference sign 26 can equally designate a film 26, which is provided as a release layer 26 or finally as an outer layer 26 for the battery assembly. By means of the separating layer 26/outer layer 26, a high degree of functional integration can be achieved, so that the production process or for the battery assembly can be provided particularly efficiently.

FIGS. 4a-d each show a side view of the battery assembly of FIGS. 2a, b during the production process according to a further embodiment. FIGS. 4e, f each show a side view of a battery assembly 1 according to the disclosure or of the battery assembly 1 from FIGS. 2a, b and FIGS. 4a-d after completion of the production process.

According to the examples shown in FIGS. 4a-f, a release layer remaining as an outer layer is not used, but an anti-adhesive agent 28 is used, which typically does not ultimately remain on or in the product to be manufactured. Accordingly, the provision S10 of an anti-adhesive agent to prevent the foaming adhesive 14 from adhering to the mold 16 is carried out by applying S12 the release agent 28 to the mold 16 (see schematic FIG. 4b). Steps S30, S40 and S50 substantially correspond to the procedure described in connection with FIGS. 3b-d.

In the course of removal S60, the foaming adhesive 14 already provides contact protection for the top of the battery block 8 (see FIG. 4e). Any residues of the release agent 28 remaining on the contact protection, i.e., on the adhesive 14, can be removed in an optional step after removal S60. For example, waiting S50 can also be until the adhesive has cured, i.e., is in the third state Z3.

Alternatively, in an optional step S62, an outer layer 26, for example in the form of a lid 26 or a film 26, can be bonded to the still tacky adhesive 14, which is thus substantially still in the second state Z2, after removal S60 (see FIG. 4f).

Alternatively, in an optional step S62, an outer layer 26 in the form of a coating 26, e.g. a lacquer 26, can be applied to the adhesive 14 in the second or third state Z2, Z3 after removal S60 (see FIG. 4f).

Using the alternatives mentioned above, the contact protection provided by the adhesive 14 can be further reinforced or made more robust.

As far as applicable, all individual features shown in the exemplary embodiments can be combined and/or interchanged without departing from the scope of the invention.

### LIST OF REFERENCE SIGNS

1 battery assembly
2 battery module
4 battery cell block
6 battery cell
8 battery cell block top side
10 electrical contacts
10a positive terminal
10b negative terminal
12 electrical connector
13 contacting element
14 foaming adhesive
16 mold
17 mold base
18 capillary area
20 adhesive beads
22 base plate, thermal plate
24 gap filler
26 anti-adhesive agent, release layer, outer layer, lid, film, lacquer
28 anti-adhesive agent, release agent
d1 average layer thickness of the foaming adhesive
d2 average height of the foaming adhesive
Z1-3 first to third state of the foaming adhesive

1. A method for producing a battery assembly for a battery module, comprising the following steps:
providing a battery cell block comprising a plurality of battery cells, wherein a battery cell block top side has one or more electrical contacts of the plurality of battery cells;
applying a foaming adhesive at least one of: onto a mold and into the mold;
positioning the battery cell block at least one of: on the mold and in the mold and inserting the battery cell block top side into the foaming adhesive so that the battery cell block top side is at least partially wetted by the foaming adhesive in order to form a contact protection for the battery cell block top side by means of the foaming adhesive;
waiting until the foaming adhesive adheres to the battery cell block top side; and
removing the battery cell block from or out of the mold.

2. The method as claimed in claim 1, wherein prior to applying the foaming adhesive at least one of: onto the mold and into the mold, the following step is carried out:
providing an anti-adhesive agent at least one of: on the mold and in the mold to prevent the foaming adhesive from adhering to the mold.

3. The method as claimed in claim 2, wherein the provision of the anti-adhesive agent is carried out at least one of: on the mold and in the mold by at least one of: using an anti-adhesive coating with which the mold is coated; and by applying a release agent to the mold.

4. The method as claimed in claim 2, wherein the provision of the anti-adhesive agent is further carried out at least one of: on the mold and in the mold by means of providing a release layer on the mold, wherein the release layer is attached to the battery cell block by means of the foaming adhesive, so that the release layer is provided in the form of an outer layer for the battery cell block top side.

5. The method as claimed in claim 1, wherein after removing the battery cell block fromout of the mold, the following step takes place:
providing the foaming adhesive with an outer layer.

6. The method as claimed in claim 4, wherein the outer layer is at least one of: a lid, a film, and a lacquer, wherein the outer layer is electrically insulating.

7. The method as claimed in claim 4, wherein the outer layer and the foaming adhesive together form a composite material, which is formed by means of layers bonded together over their entire surface.

8. The method as claimed in claim 1, further comprising at least one of the following steps:
heating the foaming adhesive prior to application to an application temperature such that the application temperature does not exceed a first threshold value; and
controlling a mold surface temperature of the mold so that the mold surface temperature does not exceed a second threshold value.

9. The method as claimed in claim 1, wherein providing the battery cell block comprises at least one of:
bonding adjacent battery cells of the plurality of battery cells to each other;
attaching the battery cell block to a bottom plate, wherein the bottom plate is a thermal plate and the battery cell block is connected to the thermal plate by means of a thermal filler material; and
attaching an electrical connector to the battery cell block top side to electrically contact the one or more electrical contacts.

10. The method as claimed in claim 4, wherein providing the release layer on or in the mold comprises:
equipping the mold with a thermoformable lid blank, wherein the lid blank comprises a PET material, a PP material or a PEF material;
thermoforming the lid blank to obtain the lid; and
cooling the lid so that the lid temperature drops to a second threshold value or below.

11. The method as claimed in claim 1, wherein the foaming adhesive is at least one of: a flame-retardant adhesive and has an open time of less than 60 seconds.

12. A battery assembly for a battery module, comprising
a battery cell block having a plurality of battery cells, wherein a battery cell block top side has one or more electrical contacts of the plurality of battery cells; and
a foaming adhesive which at least partially covers the battery cell block top side and at least partially encloses the one or more electrical contacts in order to provide contact protection for the battery cell block top side.

13. The battery assembly as claimed in claim 12, wherein an electrically insulating outer layer is arranged on the foaming adhesive.

14. The battery assembly as claimed in claim 12, wherein the outer layer and the foaming adhesive together form a composite material, which is formed from layers bonded together over their entire surface.

15. The battery assembly as claimed in claim 12, wherein the one or more electrical contacts are connected by means of an electrical connector and the foaming adhesive at least partially encloses the electrical connector.

16. The battery assembly as claimed in claim 12, wherein at least one of: at least two adjacent battery cells of the plurality of battery cells are bonded together by means of adhesive beads; and the battery cell block is attached to a base plate, wherein the base plate is a thermal plate and the battery cell block is connected to the thermal plate by means of a thermal filling material.
